(19) United States
(12) Patent Application Publication
(10) Pub. No.: US 2026/0068017 A1
(43) Pub. Date: Mar. 5, 2026

(54) ADDRESSABLE LIGHTING FAULT DETECTION

(71) Applicant: Axis Innovations, LLC, Lindon, UT (US)

(72) Inventors: Joseph Leedan Johnson, Lindon, UT (US); Grant Hagen, Lindon, UT (US); Jonathan Stott, Lindon, UT (US); Preston Pearson, Lindon, UT (US)

(21) Appl. No.: 19/313,480

(22) Filed: Aug. 28, 2025

Related U.S. Application Data
(60) Provisional application No. 63/689,351, filed on Aug. 30, 2024.

(51) Int. Cl. H05B 47/19; H05B 47/11

(52) U.S. Cl. CPC H05B 47/19; H05B 47/11

(57) ABSTRACT

A system may include a detection circuit and a controller. The detection circuit may detect a parameter of smart lights. The controller may transmit a lighting signal addressed to a portion of the smart lights. The lighting signal may cause particular channels of the portion of the smart lights to turn on. The controller may receive a parameter message from the detection circuit indicating a level of the parameter of the smart lights when the particular channels of the portion of the smart lights are on. The controller may compare the level of the parameter to a threshold value range. The controller, responsive to the level of the parameter being outside of the threshold value range, may transmit a message to a remote device. The message may indicate that the particular channels of the portion of the smart lights are not operating in accordance with a pre-determined profile.

### CROSS-REFERENCE TO RELATED APPLICATION

This patent application claims the benefit of and priority to U.S. Provisional App. No. 63/689,351 filed Aug. 30, 2024, titled “ADDRESSABLE LIGHTING FAULT DETECTION,” which is incorporated in the present disclosure by reference in its entirety.

### FIELD

The embodiments discussed in the present disclosure are related to systems and methods for addressable lighting fault detection.

### BACKGROUND

Unless otherwise indicated in the present disclosure, the materials described in the present disclosure are not prior art to the claims in the present application and are not admitted to be prior art by inclusion in this section.

Outdoor lights are commonly used to illuminate exterior areas, such as along footpaths, at the base of trees, or on roof eaves. In some outdoor lighting systems, a main controller sends instructions to one or more lights, which controls whether the lights are on or off and, in some systems, what color to illuminate and a pattern to follow. In these systems, the main controller may be electrically coupled to the lights through hardwired connections.

Over time, the lights may degrade such that the lights no longer properly illuminate, which may cause a color of the lights to change (e.g., create a fault). For example, the lights may degrade such that when the lights are instructed to illuminate a white color, the lights illuminate another color (e.g., teal or magenta) instead. Additionally or alternatively, a fault in the wiring or other components of the lighting system may occur, which may prevent the lights from illuminating all together.

In some lighting systems, to detect a fault in the lights, a person may need to notice (e.g., detect) the fault and notify an operator to perform an in person visual inspection. Additionally or alternatively, the operator may periodically visit an installation site to conduct the in person visual inspection. The in person visual inspection of the lights may include cycling the lights through different colors while the operator walks around the installation site. This may require the operator to have access to the main controller to allow the operator to turn the lights on and off and/or change the color of the lights. In addition, the in person visual inspection may be time consuming due to the time used for the operator due to time to travel to the installation site and time to perform the in person visual inspection. Further, the in person inspection may not be performed in a time manner because the person may not detect the fault soon after the fault initially occurs.

The lights may be configured to operate in accordance with operational levels for current and/or power. A fault in the wring or other components of the lighting system may create shorts or other unintended paths for current to traverse. The shorts or other paths in the lighting systems may expose portions of the lights or all the lights to levels of current and/or power that exceed their operational levels.

To prevent damage to a structure, a person, or other objects proximate the lights or damage to the lights themselves, some lighting systems may include a protective device that is configured to control or limit the levels of the current and/or power that the lights are exposed to when a fault occurs. The damage to the structure, person, other objects proximate the lights may be due to heat generated by the lights when the lights are exposed to current and/or power that exceed their operational levels. The protective device may be configured to trip (e.g., create an open) when exposed to current and/or power levels that exceed a pre-determined level. For example, the protective device may include a fuse and/or a breaker that is configured to trip when exposed to current and/or power levels that exceed the pre-determined level.

The pre-determined level may be based on a maximum load of the lights during operation (e.g., a maximum amount of power that the lights can consume). However, the pre-determined level of the protective device may be statically set, which may prevent the protective device from accounting for dynamic loads of the lights. Therefore, the protective device may only protect the lights when operating at a higher load and may not protect the lights from exposure to dangerous levels of current and/or power when the lights are operating at a lower load. Thus, the protective device may not prevent the lights from being damaged during operation at the lower load when a fault occurs.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

One or more embodiments of the present disclosure address the problems experienced in lighting systems and in person visual inspections. One or more embodiments may include a controller that is configured to automatically detect faults in the lighting system. In some embodiments, the lighting system may include a power supply and addressable smart lights (referred to in the present disclosure as “smart lights”). The controller may be communicatively coupled to the power supply and the addressable smart lights.

In some embodiments, the controller may cause the smart lights to turn on in a controlled manner. In particular, the controller may transmit a lighting signal to all the smart lights, but the lighting signal may only be addressed to one or more particular smart lights. The lighting signal may cause the one or more particular smart lights to illuminate a particular color. The power supply may include a detection circuit that detects a parameter of the smart lights connected to the power supply when the one or more particular smart lights are on.

The detection circuit may provide a parameter message to the controller. The parameter message may indicate a level of the parameter. In some embodiments, the controller may compare the level of the parameter to a corresponding threshold value range to determine whether the one or more particular smart lights are operating in accordance with a pre-determined profile (e.g., as expected). In these and other embodiments, if the level of the parameter is outside of (e.g., below, less than, above, or greater than) the corresponding threshold value range, the controller may transmit a message to a remote device indicating that a fault has been detected. Additionally or alternatively, the controller may compare the levels of the parameter corresponding to particular smart lights to each other. If a deviation between the levels of the parameter is outside of a threshold value range, the controller may transmit a message to a remote device indicating that a fault has been detected.

Embodiments disclosed in the present disclosure may permit automatic inspections of the lighting system to be performed, which may eliminate the in person visual inspection to detect faults in the lighting system. In addition, embodiments disclosed in the present disclosure may detect and specifically locate the fault in an individual smart light or a group of smart lights. For example, the message to the remote device may say “a fault detected in the smart light located two hundred feet down the strand.” Further, embodiments disclosed in the present disclosure may separately detect and separately locate multiple faults.

One or more embodiments of the present disclosure address the problems experienced by the statically set protective device. One or more embodiments of the present disclosure may include a power supply that is configured to detect dynamic levels of the current and/or the power consumed by the smart lights and compare that to a pre-determined profile to automatically adjust a protective level at which a switch in the power supply opens (e.g., an open is created) to account for the dynamic loads of the smart lights.

The power supply may include a power circuit that detects a level of a parameter of the smart lights connected to the power supply when the smart lights are operating in accordance with a frame of a lighting program. The power circuit may compare the level of the parameter to the pre-determined profile. The pre-determined profile may correspond to both the smart lights that are on and the frame of the lighting program. In other words, the pre-determined profile may indicate an expected level of the parameter of the smart lights connected to the power supply when the smart lights are operating in accordance with the frame. If the level of the parameter is greater than an expected level in the pre-determined profile, the power circuit may cause the switch in the power supply to transition to an open state to create an open and prevent the power supply from providing power to the smart lights.

Accordingly, embodiments disclosed in the present disclosure may permit automatic and/or regular adjustment of the protective level of the power supply to allow just enough current for the smart lights to operate regardless of a level of the load of the smart lights.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment that includes a power supply that includes a controller to perform fault detection of a strand of smart lights;

FIG. 2 illustrates a block diagram of an example operational environment that includes the power supply including the controller to perform fault detection of a strand of smart lights that form different branches;

FIG. 3 illustrates a block diagram of an example operational environment that includes a controller to perform fault detection of a strand of smart lights that are connected to a power supply in a first power injection arrangement;

FIG. 4A illustrates a block diagram of an example operational environment that includes the controller to perform fault detection of a strand of the smart lights that are connected to the power supply in a second power injection arrangement;

FIG. 4B illustrates a block diagram of an example operational environment that includes the controller to perform fault detection of a strand of the smart lights that are connected to multiple power supplies in a third power injection arrangement;

FIG. 5A illustrates a block diagram of an example operational environment that includes two controllers to perform fault detection of a strand of smart lights that form different branches;

FIG. 5B illustrates a block diagram of an example operational environment that includes two controllers to perform fault detection of a strand of smart lights that form different branches;

FIG. 6 illustrates a block diagram of an example operational environment that includes a controller to perform fault detection of a strand of smart lights using wireless communication;

FIG. 7 illustrates an example smart light,

FIG. 8 illustrates an example computer system that may be employed for inspecting smart lights,

all according to at least one embodiment described in the present disclosure.

### DETAILED DESCRIPTION

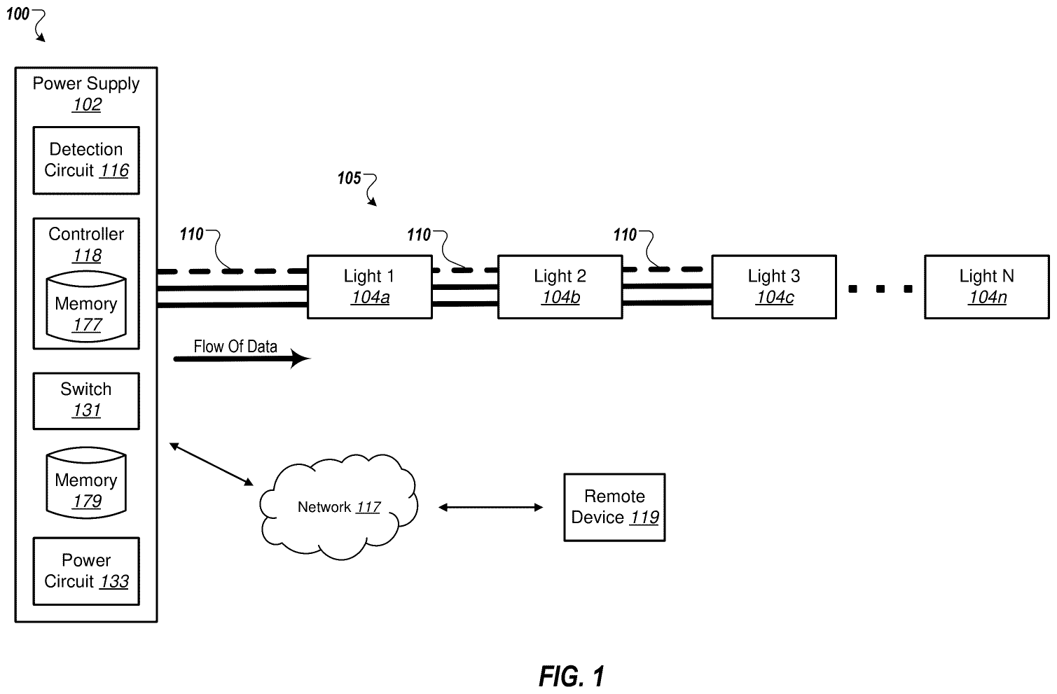

FIG. 1 illustrates a block diagram of an example operational environment 100 that includes a power supply 102 that includes a controller 118 to perform fault detection of a strand 105 of smart lights 104a-n, in accordance with at least one embodiment described in the present disclosure.

The controller 118 may transmit lighting signals to the smart lights 104a-n. The lighting signals may be addressed to one or more particular smart lights 104a-n and may cause a channel or channels of the one or more particular smart lights 104a-n to turn on. For example, the controller 118 may transmit a lighting signal to all the smart lights 104a-n, but the one or more particular smart lights may only include smart light 104a or may only include smart lights 104b, c.

The detection circuit 116 may detect a level of parameters of the smart lights 104a-n connected to the power supply 102 when the channel or channels of the one or more particular smart lights 104a-n are on. In some embodiments, the power supply 102 may provide power to each of the components within the power supply 102 but the level of the parameters may correspond only to the level of the parameters of the smart lights 104a-n that are connected to the power supply 102. The detection circuit 116 may provide a parameter message to the controller 118. The parameter message may indicate the detected level of the parameters.

In some embodiments, the controller 118 may compare the level of the parameters to threshold value ranges that are pre-determined and correspond to the one or more particular smart lights 104a-n. If the levels of the more parameters are equal to or greater than the corresponding threshold value ranges, the controller 118 may continue performing the inspection. If the levels of one or more of the parameters is below (e.g., outside of) a corresponding threshold value range, the controller 118 may transmit a message to a remote device 119 via a network 117. The message may indicate that the channel or channels of the particular smart lights 104a-n are not operating in accordance with a pre-determined profile. An operator may receive a notification, email, or other type of communication based on the message. The operator may include an installer, supplier, or a user of the smart lights 104a-n or any other appropriate person.

In some embodiments, the controller 118 may compare the level of the parameters of the particular smart lights 104a-n to each other to determine a deviation between the levels of the parameters corresponding to the channel or channels of the particular lights 104a-n. If the deviation between the levels of the parameters corresponding to the channel or channels of the particular lights 104a-n is equal to or less than a threshold value range (e.g., a deviation threshold value range), the controller 118 may continue performing the inspection. If the deviation between the levels of the parameters corresponding to the channel or channels of the particular lights 104a-n is greater than the deviation threshold value (e.g., outside of the deviation threshold value range), the controller 118 may identify a smart light of the particular smart lights 104a-n that corresponds to the deviation. For example, the controller 118 may determine that the deviation between the level of the parameters corresponding to the channel or channels of the smart light 104a and the levels of the parameters corresponding to the channel or channels of the smart lights 104b-c is greater than the deviation threshold value range and the controller 118 may identify the smart light 104a as corresponding to the deviation. Additionally, the controller 118 may transmit the message to the remote device 119 via the network 117. The message may indicate that an anomaly has been detected corresponding to the channel or channels of the identified smart light. The operator may receive the notification, email, or other type of communication based on the message.

Therefore, the controller 118 may permit automatic or continuous inspections of the smart lights 104a-n to be performed without the operator performing an in-person visual inspection or without operator supervision all together.

In some embodiments, the network 117 may use any wireless communication protocol to communicatively couple the controller 118 with the remote device 119. In some embodiments, the wireless communication protocol may include Wi-Fi®, Bluetooth®, Bluetooth Low Energy®, Zigbee®, or WiMax®. In other embodiments, the wireless communication protocol may be a network, or combination of multiple networks, configured to send and receive communications between systems and devices. For example, the wireless communication protocol may include a Personal Area Network (PAN), a Local Area Network (LAN), a Metropolitan Area Network (MAN), a Wide Area Network (WAN), a Storage Area Network (SAN), a cellular network, the Internet, a long range (LoRa) network, or some combination thereof.

Each of the smart lights 104a-n may include a power converter (not shown) for converting power received from the power supply 102 into a desired power output. For example, the smart lights 104a-n may require a specific power level to function. The power converter may convert the received power, which may be received in a variety of different voltages and forms (alternating current or direct current), into the specific power level that is required for the smart lights 104a-n to function properly. For example, the power supply 102 may provide a voltage at a level of sixty volts and the power converter may convert that to another voltage level to permit the smart lights 104a-n to function properly.

The smart lights 104a-n may include multiple channels. The channels may include one or more lighting elements, such as light emitting diodes (LEDs), that are each configured to illuminate a different color. Any number of different color channels may be included in the smart lights 104a-n. In one embodiment, a smart light may include five different color channels each including a single lighting element comprising a yellow LED, a red LED, a blue LED, a green LED, and a violet LED. Colors from these color channels may be mixed to achieve additional color outputs from the smart lights 104a-n.

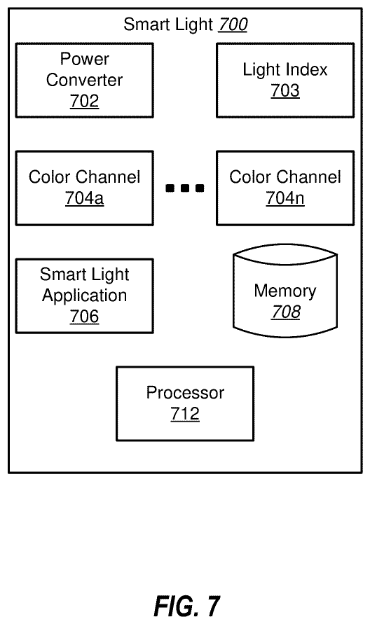

Referring to FIG. 1 and FIG. 7, each of the smart lights 104a-n may include a processor 712. The processor 712 may be configured to receive various messages and cause various messages to be transmitted to other components (e.g., 104a-n) in the environment 100. Each of the smart lights 104a-n may include a memory 708 to store data such as a corresponding address or any other data that is received from an external source. Each of the smart lights 104a-n may be assigned different addresses and may be individually addressable and the processor 712 may be configured to store the corresponding address in a memory 708 of the smart lights 104a-n. For example, the smart light 104a may be addressed “Light 1”, the smart light 104b may be addressed “Light 2”, the smart light 104c may be addressed “Light 3”, and the Nth smart light 104n may be addressed “Light N” and each processor may be configured to store data representative of the corresponding address.

Referring back to FIG. 1, the environment 100 is illustrated as including a first smart light 104a, a second smart light 104b, a third smart light 104c, and a Nth smart light 104n for example purposes. As indicated by the ellipsis and the Nth smart light 104n in FIG. 1, the environment 100 may include any appropriate number of smart lights 104a-n.

The power supply 102 may include the detection circuit 116 or the controller 118. The power supply 102 may house the detection circuit 116 and the controller 118 with power supply components in the same housing. The detection circuit 116 may configured to detect a parameter of the smart lights 104a-n connected to the power supply 102 during operation of one or all the smart lights 104a-n. The parameter may include a level of current, a level of power, or a level of voltage of the smart lights 104a-n that are connected to the power supply 102. In some embodiments, the level of the parameter may be different for different channels. For example, the level of current and/or the level of power of the smart lights 104a-n that are connected to the power supply 102 may be greater for a white channel compared to a blue channel or a green channel.

The controller 118 may include a memory 177 to store data such as a pre-determined profile, threshold value ranges, a corresponding address, or any other data that is received from an external source. The controller 118 may be communicatively coupled to the smart lights 104a-n via a wire 110 to provide messages to the smart lights 104a-n. In some embodiments, the controller 118 may be configured to perform unidirectional communication with the smart lights 104a-n. In other words, the controller 118 may transmit a message and forget the message (e.g., not wait for a response because not response is coming). The processors 712 of the smart lights 104a-n may receive the messages and determine whether the messages are directed to them based on the addresses.

The controller 118 may be configured to perform the inspection based one or more factors. The factors may include an amount of time the smart lights 104a-n have been operating, an amount of time since an inspection was last performed, power up of the power supply 102, or any other appropriate factor. Additionally or alternatively, the controller 118 may be configured to continuously monitor the parameters of the smart lights 104a-n connected to the power supply 102 and may be configured to perform a more thorough inspection based on one or more of the parameters changing. For example, the detection circuit 116 may detect an overall power level of the smart lights 104a-n during operation and if that overall power level reduces a pre-determined amount, the controller 118 may perform an inspection of individual or groups of the smart lights 104a-n.

In some embodiments, the controller 118 may perform inspection of groups of the smart lights 104a-n to reduce an amount of time to inspect the entire strand 105 compared to inspecting each individual smart light 104a-n. In other embodiments, the controller 118 may perform the inspection of individual smart lights 104a-n so that the fault can be tied to an individual smart light 104a-n. In some embodiments, the controller 118 may initially perform the inspection of the groups of the smart lights 104a-n to quickly locate a section of the strand 105 that is experiencing a fault and then the controller 118 may perform the inspection of individual smart lights 104a-n within the group of smart lights 104a-n.

An example of the controller 118 performing the inspection of a white channel of two portions of the smart lights 104a-b will now be discussed. The controller 118 may transmit a first lighting signal to the smart lights 104a-n. The first lighting signal may be addressed to only the smart lights 104a-b and not to the smart lights 104c-n. Accordingly, the smart lights 104c-n may disregard the first lighting signal. The first lighting signal may cause the white channels for the smart lights 104a-b to turn on.

The detection circuit 116 may detect (e.g., measure) the parameter(s) of the smart lights 104a-n that are connected to the power supply 102 when the white channels of the smart lights 104a-b are on. In addition, the detection circuit 116 may transmit a first parameter message to the controller 118. The first parameter message may indicate the level(s) of the parameter(s) of the smart lights 104a-n that are connected to the power supply 102 when the white channels of the smart lights 104a-b are on.

The controller 118 may compare the detected level(s) of the parameter(s) of the smart lights 104a-n that are connected to the power supply 102 when the white channels of the smart lights 104a-b are on to the threshold value range(s) that correspond to the white channels for the smart lights 104a-b. In other words, the controller 118 may compare the detected level(s) of specific channel(s) (e.g., a specific color) to corresponding threshold value range(s) for that specific channel(s). For example, a threshold current value for the white channels may be two milliamps and the controller 118 may compare the detected current(s) to two to three milliamps. Additionally or alternatively, the controller 118 may determine a level of power of the white channels based on a detected level of current and level of voltage of the power supply 102. The controller 118 may compare the determined level of power of the white channels to a power threshold value range.

Responsive to the detected level(s) of the parameter(s) of the smart lights 104a-n that are connected to the power supply 102 being equal to or greater than the threshold value range(s), the controller 118 may proceed to inspect a second portion of the smart lights 104a-n. Responsive to the detected level of the parameter(s) of the smart lights 104a-n that are connected to the power supply 102 being less than (e.g., outside of) the threshold value range(s), the controller 118 may generate a first message indicating that the white channels of the smart lights 104a-b are not operating in accordance with a pre-determined profile. Additionally, the controller 118 may transmit the first message to the remote device 119. Alternatively, the controller 118 may wait until all the smart lights 104a-n have been inspected before sending any messages to the remote device 119. The remote device 119 may generate a notification, either on a screen (not shown) of the remote device 119 or another device or via email, informing the operator of the detected fault.

The controller 118 may transmit a termination signal to the smart lights 104a-n. In some embodiments, the termination signal may be addressed to only smart lights 104a-b (e.g., the smart lights that were previously inspected and on). In other embodiments, the termination signal may be addressed to all the smart lights 104a-n to ensure all the smart lights 104a-n are off. The termination signal may cause the white channels of the smart lights 104a-b to turn off. In some embodiments, the terminal signal may include a subsequent lighting signal. In these and other embodiments, the subsequent lighting signal may indicate which of the smart lights 104a-n are to turn on and which of the smart lights 104a-n are to turn off. The operations described in the present disclosure as being based on or involving the termination signal, therefore, may be based on or involve the subsequent lighting signals instead.

The controller 118 may transmit a second lighting signal to the smart lights 104a-n. The second lighting signal may be addressed to only smart lights 104c-n and not to smart lights 104a-b. Accordingly, the smart lights 104a-b may disregard the second lighting signal. The second lighting signal may cause the white channels for the smart lights 104c-n to turn on.

The detection circuit 116 may detect (e.g., measure) the parameter(s) of the smart lights 104a-n that are connected to the power supply 102 when the white channels of the smart lights 104c-n are on. In addition, the detection circuit 116 may transmit a second parameter message to the controller 118. The second parameter message may indicate the level(s) of the parameter(s) of the smart lights 104a-n that are connected to the power supply 102 when the white channels of the smart lights 104c-n are on.

The controller 118 may compare the detected level(s) of the parameter(s) of the smart lights 104a-n that are connected to the power supply 102 when the white channels of the smart lights 104c-n are on to the threshold value range(s) that correspond to the white channels for the smart lights 104c-n.

Responsive to the detected level(s) of the parameter(s) of the smart lights 104a-n that are connected to the power supply 102 being equal to or greater than the threshold value range(s), the controller 118 may proceed to inspect other portions of the smart lights 104a-n. Responsive to the detected level(s) of the parameter(s) of the smart lights 104a-n that are connected to the power supply 102 being less than (e.g., outside of) the threshold value range(s), the controller 118 may generate a second message indicating that the white channels of the smart lights 104c-n are not operating in accordance with a pre-determined profile. Additionally, the controller 118 may transmit the second message to the remote device 119. The remote device 119 may generate a notification, either on a screen (not shown) of the remote device or another device or via email, informing the operator of the detected fault. The operator may include an installer, supplier, or a user of the smart lights 104a-n or any other appropriate person.

In some embodiments, the controller 118 may wait for all the smart lights 104a-n to be inspected and combine any information into a single message. For example, the controller 118 may combine the first message and the second message together into a single message.

An example of the controller 118 performing the inspection of a blue channel of two individual smart lights 104a-b using the pre-determined profile will now be discussed. The controller 118 may transmit a first lighting signal to the smart lights 104a-n. The first lighting signal may be addressed to only the smart light 104a and not to the smart lights 104b-n. Accordingly, the smart lights 104b-n may disregard the first lighting signal. The first lighting signal may cause the blue channel for the smart light 104a to turn on.

The detection circuit 116 may detect (e.g., measure) the parameter(s) of the smart lights 104a-n that are connected to the power supply 102 when the blue channel of the smart light 104a is on. In addition, the detection circuit 116 may transmit a parameter message to the controller 118. The parameter message may indicate the level(s) of the parameter(s) of the smart lights 104a-n that are connected to the power supply 102 when the blue channel of the smart light 104a is on.

The controller 118 may compare the detected level(s) of the parameter(s) of the smart lights 104a-n that are connected to the power supply 102 when the blue channel of the smart lights 104a is on to the threshold value range(s) that correspond to the blue channel for the smart light 104a.

Responsive to the detected level(s) of the parameter(s) of the smart lights 104a-n that are connected to the power supply 102 being equal to or greater than the threshold value range(s), the controller 118 may proceed to inspect the smart light 104b. Responsive to the detected level(s) of the parameter(s) of the smart lights 104a-n that are connected to the power supply 102 being less than (e.g., outside of) the threshold value range(s), the controller 118 may generate a first message indicating that the blue channel of the smart light 104a is not operating in accordance with a pre-determined profile. Additionally, the controller 118 may transmit the first message to the remote device 119. Alternatively, the controller 118 may wait until all the smart lights 104a-n have been inspected before sending any messages to the remote device 119. The remote device 119 may generate a notification, either on a screen (not shown) of the remote device or another device or via email, informing the operator of the detected fault.

The controller 118 may transmit a termination signal to the smart lights 104a-n to cause the blue channel of the smart light 104a to turn off. The controller 118 may transmit a second lighting signal to the smart lights 104a-n. The second lighting signal may be addressed to only smart light 104b and not to the smart lights 104a, c-n. Accordingly, the smart lights 104a, c-n may disregard the second lighting signal. The second lighting signal may cause the blue channel for the smart light 104b to turn on.

The detection circuit 116 may detect the parameter(s) of the smart lights 104a-n that are connected to the power supply 102 when the blue channel of the smart light 104b is on. In addition, the detection circuit 116 may transmit a second parameter message to the controller 118. The second parameter message may indicate the level(s) of the parameter(s) of the smart lights 104a-n that are connected to the power supply 102 when the blue channel of the smart light 104b is on.

The controller 118 may compare the detected level(s) of the parameter(s) of the smart lights 104a-n that are connected to the power supply 102 when the blue channel of the smart light 104b is on to the threshold value range(s) that correspond to the blue channel for the smart light 104b.

Responsive to the detected level(s) of the parameter(s) of the smart lights 104a-n that are connected to the power supply 102 being equal to or greater than the threshold value range(s), the controller 118 may proceed to inspect the other smart lights 104a, c-n. Responsive to the detected level(s) of the parameter(s) of the smart lights 104a-n that are connected to the power supply 102 being less than the threshold value range(s), the controller 118 may generate a second message indicating that the blue channel of the smart light 104b is not operating in accordance with the pre-determined profile. Additionally, the controller 118 may transmit the second message to the remote device 119.

In some embodiments, the pre-determined profile may be based on a linear footage of the strand 105 of the smart lights 104a-n. In these and other embodiments, the pre-determined profile may be based on factory ratings of the channels (e.g., the LEDs) of the smart lights 104a-n.

In some embodiments, the controller 118 may be configured to generate the pre-determined profile during installation or at any appropriate point in time. In some embodiments, the controller 118 may generate the pre-determined profile based on messages indicating a fault has been detected. The controller 118 may generate the pre-determined profile to represent what the parameters of a working lighting system should be. In addition, the controller 118 may store the pre-determined profile in the memory 177.

To generate the pre-determined profile, the controller 118 may transmit a first lighting signal to the smart lights 104a-n. The first lighting signal may cause first channels of the smart lights 104a-n to turn on. The detection circuit 116 may detect the parameter(s) of the smart lights 104a-n that are connected to the power supply 102 when the first channels of the smart lights 104a-n are on.

The detection circuit 116 may transmit a first parameter message to the controller 118. The first parameter message may indicate the level(s) of the parameter(s) of the smart lights 104a-n that are connected to the power supply 102 when the first channels of the smart lights 104a-n are on. The controller may transmit a termination signal to the smart lights 104a-n to cause the first channels of the smart lights 104a-n to turn off.

The controller 118 may transmit a second lighting signal to the smart lights 104a-n. The second lighting signal may cause second channels of the smart lights 104a-n to turn on. The detection circuit 116 may detect the parameter(s) of the smart lights 104a-n that are connected to the power supply 102 when the second channels of the smart lights 104a-n are on. The detection circuit 116 may transmit a second parameter message to the controller 118. The second parameter message may indicate the level(s) of the parameter(s) of the smart lights 104a-n that are connected to the power supply 102 when the second channels of the smart lights 104a-n are on.

The controller 118 may generate the pre-determined profile of the first channels based on the first parameter message. Additionally or alternatively, the controller 118 may generate the pre-determined profile of the second channels based on the second parameter message. The pre-determined profile of the first channels and/or the second channels may include threshold value range(s) of the corresponding parameter(s) of the smart lights 104a-n that are connected to the power supply 102.

An example of the controller 118 performing the inspection of a red channel of three individual smart lights 104a-c using a deviation of the levels of parameters corresponding to the smart lights 104a-c will now be discussed. The controller 118 may transmit a first lighting signal to the smart lights 104a-n. The first lighting signal may be addressed to only the smart light 104a and not to the smart lights 104b-n. Accordingly, the smart lights 104b-n may disregard the first lighting signal. The first lighting signal may cause the blue channel for the smart light 104a to turn on.

The detection circuit 116 may detect (e.g., measure) the parameter(s) of the smart lights 104a-n that are connected to the power supply 102 when the red channel of the smart light 104a is on. In addition, the detection circuit 116 may transmit a first parameter message to the controller 118. The first parameter message may indicate the level(s) of the parameter(s) of the smart lights 104a-n that are connected to the power supply 102 when the red channel of the smart light 104a is on. For example, the first parameter message may indicate that the detected current level of the smart lights 104a-n when the red channel of the smart light 104a is on is equal to five hundred milliamps.

The controller 118 may transmit a first termination signal to the smart lights 104a-n to cause the red channel of the smart light 104a to turn off. The controller 118 may transmit a second lighting signal to the smart lights 104a-n. The second lighting signal may be addressed to only smart light 104b and not to the smart lights 104a, c-n. Accordingly, the smart lights 104a, c-n may disregard the second lighting signal. The second lighting signal may cause the red channel for the smart light 104b to turn on.

The detection circuit 116 may detect (e.g., measure) the parameter(s) of the smart lights 104a-n that are connected to the power supply 102 when the red channel of the smart light 104b is on. In addition, the detection circuit 116 may transmit a second parameter message to the controller 118. The second parameter message may indicate the level(s) of the parameter(s) of the smart lights 104a-n that are connected to the power supply 102 when the red channel of the smart light 104a is on. For example, the second parameter message may indicate that the detected current level when the red channel of the smart light 104b is on is equal to four hundred eighty three milliamps.

The controller 118 may transmit a second termination signal to the smart lights 104a-n to cause the red channel of the smart light 104b to turn off. The controller 118 may transmit a third lighting signal to the smart lights 104a-n. The third lighting signal may be addressed to only smart light 104c and not to the smart lights 104a, b, d-n. Accordingly, the smart lights 104a, b, d-n may disregard the third lighting signal. The third lighting signal may cause the red channel for the smart light 104c to turn on.

The detection circuit 116 may detect (e.g., measure) the parameter(s) of the smart lights 104a-n that are connected to the power supply 102 when the red channel of the smart light 104c is on. In addition, the detection circuit 116 may transmit a third parameter message to the controller 118. The third parameter message may indicate the level(s) of the parameter(s) of the smart lights 104a-n that are connected to the power supply 102 when the red channel of the smart light 104c is on. For example, the third parameter message may indicate that the detected current level when the red channel of the smart light 104c is on is equal to two milliamps.

The controller 118 may compare the detected level(s) of the parameter(s) of the smart lights 104a-n that are connected to the power supply 102 when the red channel of the smart lights 104a, b, c are on to each other. In particular, the controller 118 may determine a deviation (e.g., a difference) between the detected level(s) of the parameter(s) of the smart lights 104a-n that are connected to the power supply 102 when the red channel of the smart lights 104a-c are on. For example, the controller 118 may determine that the difference between the detected current when the red channel of the smart lights 104a, b are on is equal to seventeen milliamps, the difference between the detected current when the red channel of the smart lights 104a, c are on is equal to four hundred ninety eight milliamps, and the difference between the detected current when the red channel of the smart lights 104b, c are on is four hundred eighty one milliamps.

Responsive to the deviation between one or more of the detected level(s) of the parameter(s) of the smart lights 104a-n that are connected to the power supply 102 corresponding to the red channel of the particular lights 104a-c being equal to or less than the deviation threshold value range, the controller 118 may proceed to inspect other smart lights 104a-n or other combinations of the smart lights 104a-n. Responsive to the deviation between one or more of the detected level(s) of the parameter(s) of the smart lights 104a-n that are connected to the power supply 102 corresponding to the red channel of the particular lights 104a-c being greater than (e.g., outside of) the deviation threshold value range, the controller 118 may identify the smart light 104a-c that is not operating as expected. For example, the controller 118 may identify that the smart light 104c is not operating as expected based on the deviation between it and smart light 104a being equal to four hundred ninety eight milliamps and/or the deviation between it and smart light 104b being equal to four hundred eighty one milliamps. Additionally, the controller 118 may generate a message indicating that the red channel of the one or more identified smart lights 104a-c are not operating as expected. For example, the message may indicate that the red channel of the smart light 104c is not operating as expected.

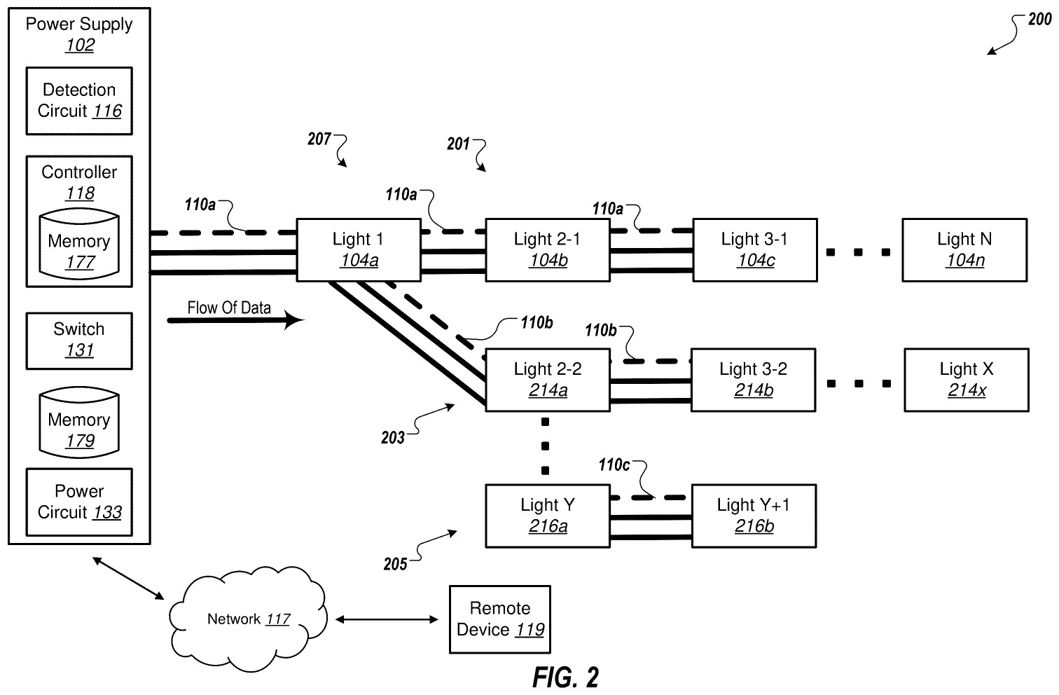

FIG. 2 illustrates a block diagram of an example operational environment 200 that includes the power supply 102 including the controller 118 to perform fault detection of a strand 207 of smart lights 104a-n, 214a-x, 216a-b that form different branches 201, 203, 205, in accordance with at least one embodiment described in the present disclosure. The smart lights 214a-x, 216a-b may correspond to the smart lights 104a-n as described above. A number of the smart lights 104a-n, 214a-x, 216a-b in the different branches 201, 203, 205 could be the same or different from other branches 201, 203, 205.

The strand 207 includes three different branches 201, 203, 205 that are formed by runs of wires branching from a main run of wires. The branches 201, 203, 205 may be parallel to each other. Due to the branches 201, 203, 205 being parallel to each other and communication from the controller 118 being unilateral, the addresses for parallel smart lights may be the same or similar in relation to the controller 118. For example, the address for the smart light 104b and the smart light 214a may be the same in relation to the controller 118, which means messages addressed to the smart light 104b will also be addressed to the smart light 214a.

Accordingly, inspection of the smart lights 104b-n, 214a-x, and 216a-b may be performed in parallel groups and the threshold value ranges may be multiples of the threshold value range in relation to a single smart light. For example, the threshold value range(s) for the smart lights 104c, 214b, and 216b may be equal to the threshold value range(s) of single smart lights multiplied by three.

The controller 118 may inspect the smart lights 104a-n, 214a-x, 216a-b in similar manners as discussed above in relation to FIG. 1, but will account for the duplicative nature of the parallel branches 201, 203, 205 when comparing detected value(s) to corresponding threshold value range(s). For example, the controller 118 may inspect the smart lights 104b-n, 214a-x, 216a-b individually or in groups.

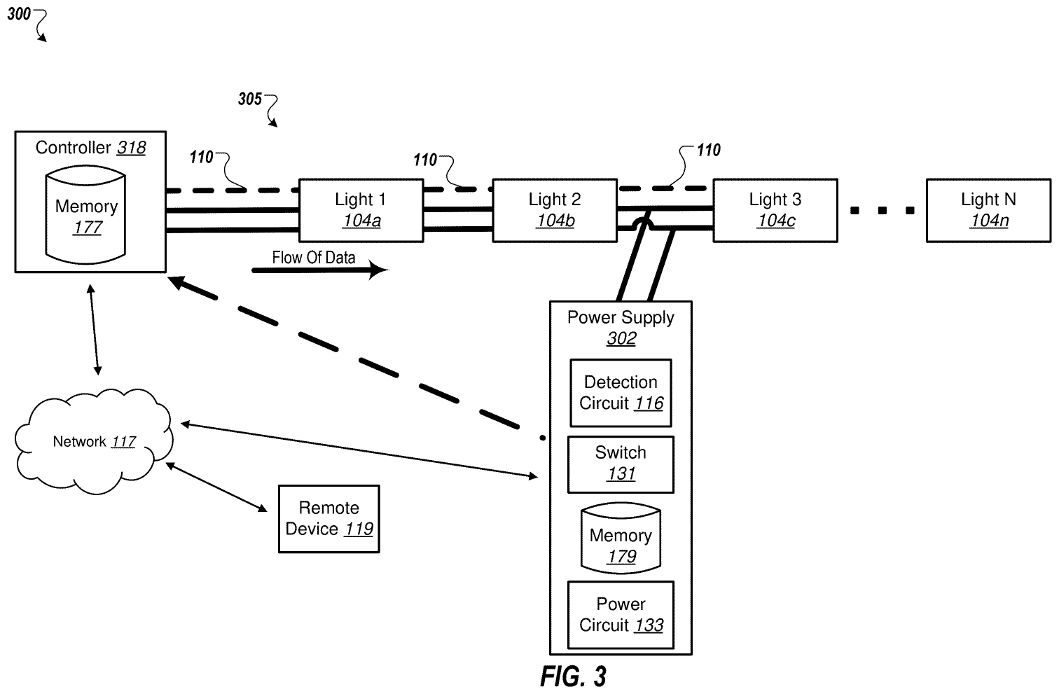

FIG. 3 illustrates a block diagram of an example operational environment 300 that includes a controller 318 to perform fault detection of a strand 305 of smart lights 104a-n that are connected to a power supply 302 in a first power injection arrangement, in accordance with at least one embodiment described in the present disclosure. In the first power injection arrangement, the power supply 302 may be electrically coupled between two instances of the smart lights 104a-n but may be electrically coupled to the smart lights 104a-n via single runs of wire. As shown in FIG. 3, the power supply 302 is electrically coupled between the smart light 104b and the smart light 104c.

The controller 318 may include an endpoint receiver that is remote from the power supply 302 and the detection circuit 116. The controller 318 may communicate with the power supply 302, the detection circuit 116, or both via a wireless communication link (represented by the dashed line in FIG. 3). In some embodiments, the wireless communication link may use any wireless communication protocol to communicatively couple the controller 318 with the remote device 119. In some embodiments, the wireless communication protocol may include Wi-Fi®, Bluetooth®, Bluetooth Low Energy®, Zigbee®, or WiMax®. In other embodiments, the wireless communication protocol may be a network, or combination of multiple networks, configured to send and receive communications between systems and devices. For example, the wireless communication protocol may include a Personal Area Network (PAN), a Local Area Network (LAN), a Metropolitan Area Network (MAN), a Wide Area Network (WAN), a Storage Area Network (SAN), a cellular network, the Internet, a long range (LoRa) network, or some combination thereof. Alternatively, the controller 318 may communicate with the power supply 302, the detection circuit 116, or both via a wired link.

The controller 118 may inspect the smart lights 104a-n in the same or similar manners as the controller 118 discussed above in relation to FIG. 1. In particular, the controller 318 may inspect the smart lights 104a-n individually or in groups. However, the controller 318 may provide a synchronization message to the detection circuit 116, the power supply 302, or both to ensure the detection circuit 116 is functioning at appropriate times or detecting the proper parameter(s) at the correct times.

The controller 318 may transmit the synchronization signal to the power supply 302, the detection circuit 116, or both. In some embodiments, the detection circuit 116 may start detecting the level(s) of the parameter(s) of the smart lights 104a-n that are connected to the power supply 302 in response to receiving the synchronization signal.

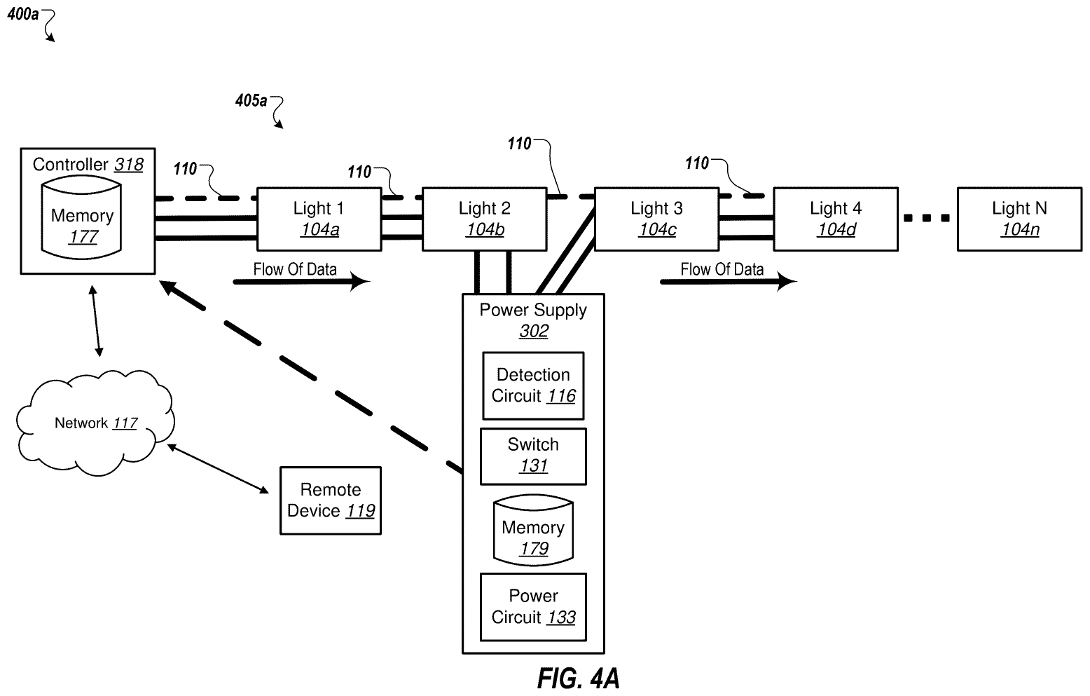

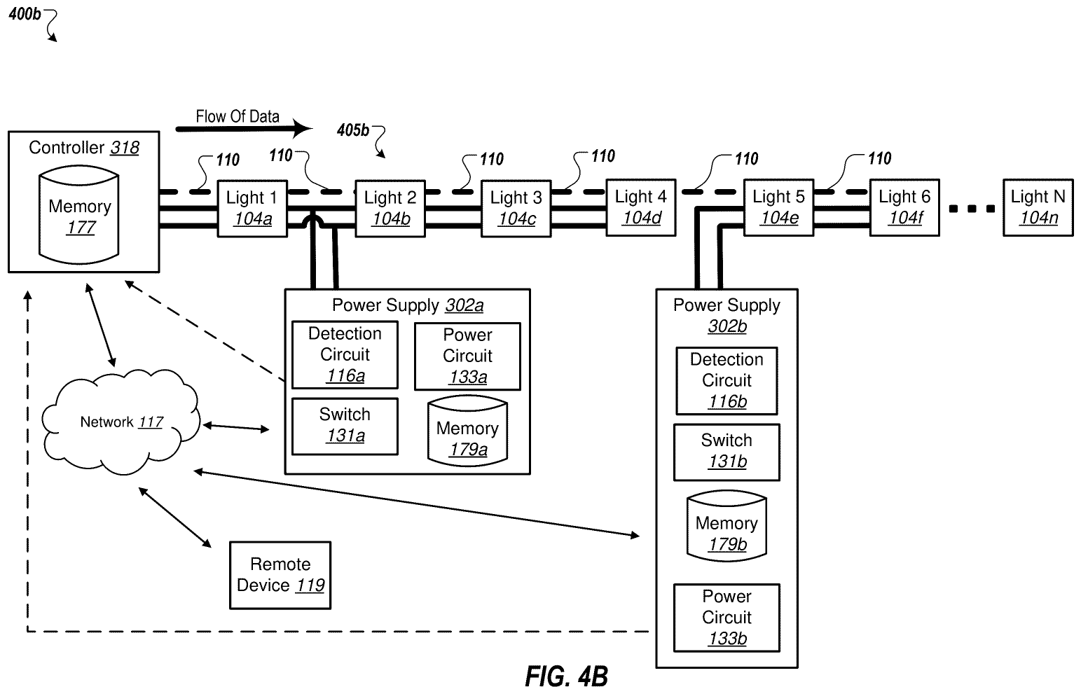

FIG. 4A illustrates a block diagram of an example operational environment 400a that includes the controller 318 to perform fault detection of a strand 405a of the smart lights 104a-n that are connected to the power supply 302 in a second power injection arrangement, in accordance with at least one embodiment described in the present disclosure. In the second power injection arrangement, the power supply 302 may be electrically coupled between two instances of the smart lights 104a-n and may be electrically coupled to the smart lights 104a-n via two different runs of wires. As shown in FIG. 4A, the power supply 302 is electrically coupled between the smart lights 104b-c and is electrically coupled to the smart lights 104a-b via a first run of wires and is electrically coupled to the smart lights 104c-n via a second run of wires.

The controller 318 may inspect the smart lights 104a-n as described above. However, the synchronization signal would also indicate which run of wires the detection circuit 116 is to detect the parameter(s) on. For example, the controller 318 may inspect the smart lights 104c-n and the synchronization signal may instruct the detection circuit 116 to detect the parameter(s) on the second run of wires.

FIG. 4B illustrates a block diagram of an example operational environment 400b that includes the controller 318 to perform fault detection of a strand 405b of the smart lights 104a-n that are connected to multiple power supplies 302a-b in a third power injection arrangement, in accordance with at least one embodiment described in the present disclosure. In the third power injection arrangement, the power supply 302a may be electrically coupled between different instances of the smart lights 104a-d and may be electrically coupled to the smart lights 104a-d via a first run of wires. In addition, in the third power injection arrangement, the power supply 302b may be electrically coupled to the smart lights 104e-n and may be electrically coupled to the smart lights 104e-n via a second run of wires.

The controller 318 may inspect the smart lights 104a-n as described above. However, the synchronization signal would also indicate which run of wires and/or which detection circuit 116a-b of the power supplies 302a-b is to detect the parameter(s). For example, the controller 318 may inspect the smart lights 104a-d and the synchronization signal may instruct the detection circuit 116a of the power supply 302a to detect the parameter(s) on the first run of wires.

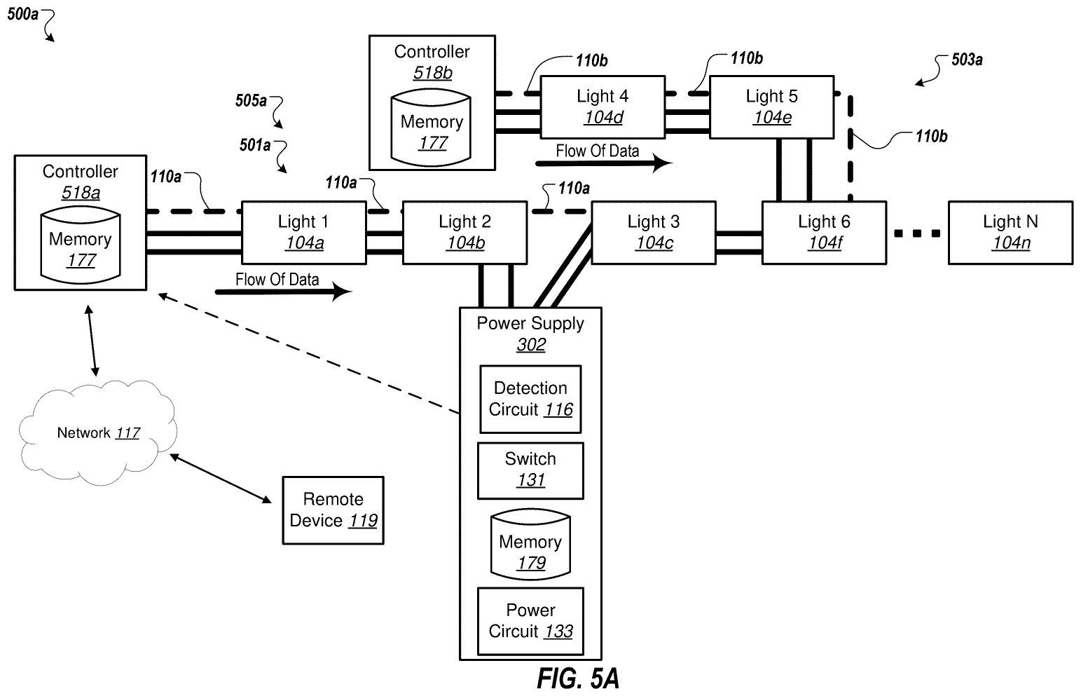

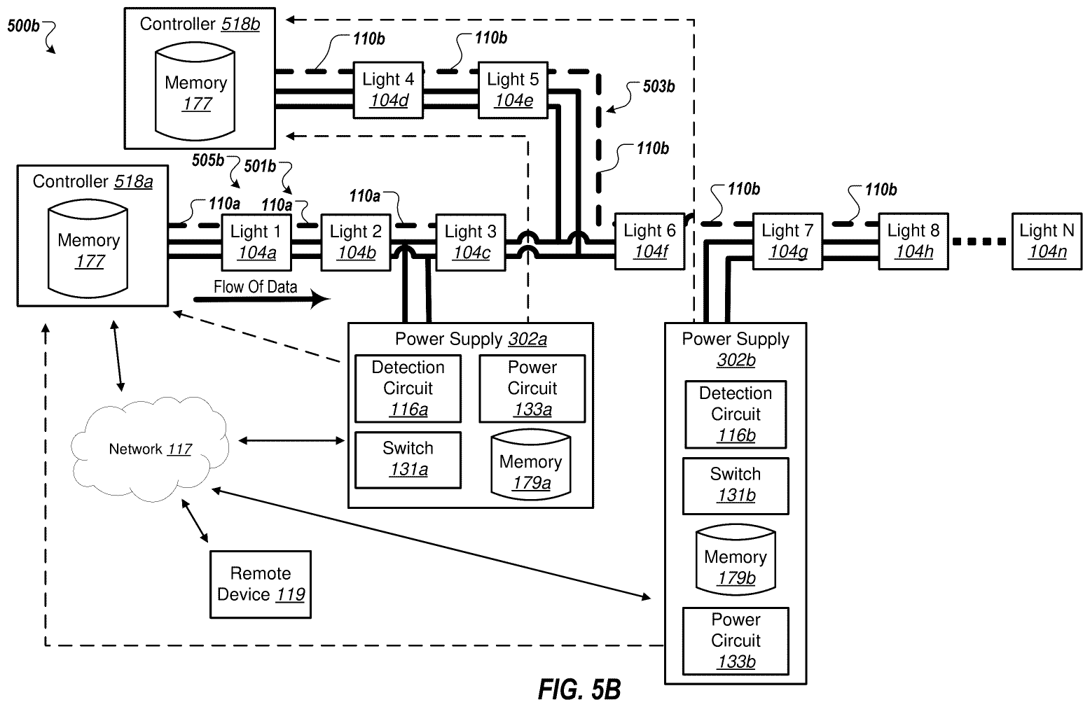

FIG. 5A illustrates a block diagram of an example operational environment 500a that includes two controllers 518a-b to perform fault detection of a strand 505a of smart lights 104a-n that form different branches 501a, 503a, in accordance with at least one embodiment described in the present disclosure. The power supply 302 may be electrically coupled to the smart lights 104a-n in a fourth power injection arrangement.

In the fourth power injection arrangement, the power supply 302 may be electrically coupled between two instances of the smart lights 104a-n and may be electrically coupled to the smart lights 104a-n via two different runs of wires. As shown in FIG. 5A, the power supply 302 is electrically coupled between the smart lights 104b-c and is electrically coupled to the smart lights 104a-b via a first run of wires and is electrically coupled to the smart lights 104c-n via a second run of wires. In addition, as shown in FIG. 5A, the first controller 518a may be communicatively coupled to the smart light 104c despite the smart light 104c being electrically coupled to the power supply 302 via a different run of wires.

The controllers 518a-b may operate the same as or similar to the controllers 118, 318 described above. However, each of the controllers 518a-b may only inspect the smart lights 104a-n that are connected to the controllers 518a-b via the corresponding run of wires 110a-b. For example, the controller 518a may inspect the smart lights 104a-c individually or in groups as described above or the controller 518b may inspect the smart lights 104d-n individually or in groups as described above.

Additionally, each of the controllers 518a-b may be configured to transmit synchronization signals to the power supply 302 or the detection circuit 116 to indicate which run of wires the detection circuit 116 is to detect the parameter(s) on.

FIG. 5B illustrates a block diagram of an example operational environment 500b that includes two controllers 518a-b to perform fault detection of a strand 505b of smart lights 104a-n that form different branches 501b, 503b, in accordance with at least one embodiment described in the present disclosure. The example operational environment 500b may include two power supplies 302a-b electrically coupled to the smart lights 104a-n in a fifth power injection arrangement.

In the fifth power injection arrangement, the power supply 302a may be electrically coupled between different instances of the smart lights 104b-c and may be electrically coupled to the smart lights 104a-f via a first run of wires. In addition, in the fifth power injection arrangement, the power supply 302b may be electrically coupled to the smart lights 104g-n and may be electrically coupled to the smart lights 104g-n via a second run of wires.

The controllers 518a-b may operate the same as or similar to the controllers 118, 318 described above. However, each of the controllers 518a-b may only inspect the smart lights 104a-n that are connected to the controllers 518a-b via the corresponding run of wires 110a-b. For example, the controller 518a may inspect the smart lights 104a-c individually or in groups as described above or the controller 518b may inspect the smart lights 104d-n individually or in groups as described above.

Additionally, each of the controllers 518a-b may be configured to transmit synchronization signals to the power supplies 302a-b or the detection circuits 116a-b of the power supplies 302a-b to indicate which run of wires and/or which detection circuit 116a-b of the power supplies 302a-b are to detect the parameter(s).

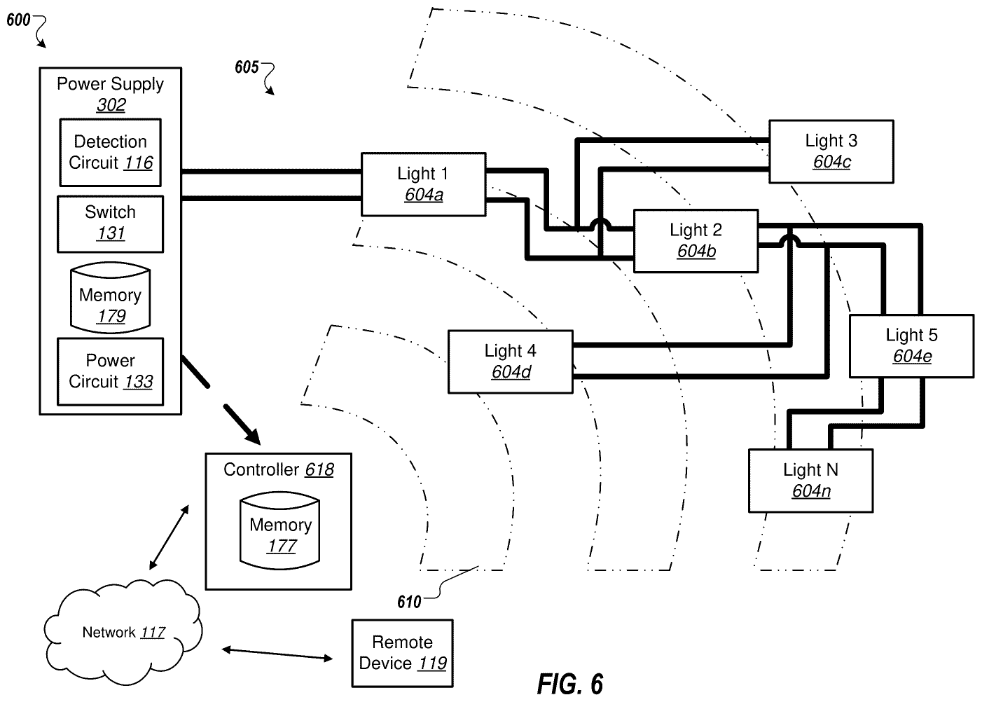

FIG. 6 illustrates a block diagram of an example operational environment 600 that includes a controller 618 to perform fault detection of a strand 605 of smart lights 604a-n using wireless communication, in accordance with at least one embodiment described in the present disclosure. The power supply 302 may be electrically coupled to the smart lights 604a-n via a single run of wires that includes branches similar to what is discussed above in relation to FIG. 2.

The controller 618 may operate the same as or similar to the controllers 118, 318, 518a-b described above except that the controller 618 may be configured to transmit signals to the smart lights 604a-n via a wireless communication link (represented by 610). For example, the controller 618 may transmit the lighting signals, the termination signals, or both via the wireless communication link 610. In some embodiments, the wireless communication link 610 may use any wireless communication protocol to communicatively couple the controller 618 with the smart lights 604a-n. In some embodiments, the wireless communication protocol may include Wi-Fi®, Bluetooth®, Bluetooth Low Energy®, Zigbee®, or WiMax®. In other embodiments, the wireless communication protocol may be a network, or combination of multiple networks, configured to send and receive communications between systems and devices. For example, the wireless communication protocol may include a Personal Area Network (PAN), a Local Area Network (LAN), a Metropolitan Area Network (MAN), a Wide Area Network (WAN), a Storage Area Network (SAN), a cellular network, the Internet, a long range (LoRa) network, or some combination thereof.

FIG. 7 illustrates an example smart light 700. The smart light 700 may be any of the smart lights 104a-n, 214a-x, 216a-b, 604a-n described above. The smart light 700 includes the power converter 702 for converting power received from a power supply into a desired power output.

The smart light 700 includes a light index 703. Each smart light in a lighting system may include a unique light index (e.g., address). This light index may be a symbol or an alphanumeric character, such as a number, that uniquely identifies each smart light within the system. Light indices may also be a series of numbers, such as coordinates in a two-or three-dimensional space that identify locations of the lights in the system. In one embodiment, light indices may be assigned during an initial set up process in which the smart lights 104a-n, 214a-x, 216a-b, 604a-n are paired with the controllers 118, 318, 518a-b, 618. For example, the smart lights 104a-n, 214a-x, 216a-b, 604a-n may be numerically indexed chronologically based on the order in which they paired to the controllers 118, 318, 518a-b, 618. In some embodiments, the light indices assigned to smart lights in a system may be changed by a user subsequent to pairing with the controllers 118, 318, 518a-b, 618.

The smart light 700 also includes a plurality of color channels 704a-704n. These color channels 704a-n may include the lighting elements, such as light emitting diodes (LEDs), that are each configured to illuminate a different color.

The smart light 700 also includes a smart light application 706. The smart light application 706 may be configured to communicate with an external source, such as a main controller. The smart light 700 may receive data, such as a lighting program and a synchronization signal from the main controller. The smart light 700 may also transmit data to the main controller, such as a confirmation that a lighting program has been received. Each of these transmissions may be sent and received as modified 2.4 GHz Wi-Fi® packets over the wireless communication link.

The smart light 700 also includes the memory 708. The smart light 700 may use the memory 708 to store a lighting program and other data that is received from an external source, such as the main controller. The smart light 700 also includes a processor 712. The processor 712 may be configured to render a lighting program or control other operations of the smart light 700.

Referring to FIG. 1, the power supply 102 may include a power circuit 133 and a switch 131. The power supply 102 may house the power circuit 133 and the switch 131 with power supply components in the same housing. The power circuit 133 may configured to detect a level of a parameter of the smart lights 104a-n that are connected to the power supply 102 during operation of one or all the smart lights 104a-n. The level of the parameter may include a level of current, a level of power, or a level of voltage of the smart lights 104a-n that are connected to the power supply 102. In some embodiments, the level of the parameter may be different for different frames of a lighting program. For example, the level of the current and/or the level of the power of the power supply 102 may be greater for a first frame in which a white channel of one or more of the smart lights 104a-n is on compared to frames in which a blue channel or a green channel of the smart lights 104a-n are on.

The power supply 102 may include a memory 179 to store data such as the pre-determined profile, threshold value ranges, a corresponding address, or any other data corresponding to dynamic power protection of the smart lights 104a-n that is received from an external source. Additionally or alternatively, the power supply 102 may store the data in the memory 177 of the controller 118.

The switch 131 may configured to transition between an open state and a closed state to selectively electrically couple the smart lights 104a-n to the power supply 102. In the open state, the switch 131 may create an open and disconnect the smart lights 104a-n from the power supply (e.g., prevent the smart lights 104a-n from receiving power from the power supply 102). In the closed state, the switch 131 may electrically couple the smart lights 104a-n to the power supply 102 to permit the power supply 102 to provide power to the smart lights 104a-n.

The power supply 102 may perform power protection of the smart lights 104a-n based on one or more factors. The factors may include power up of the power supply 102, generation of the pre-determined profile, a synchronization signal, or any other appropriate factor. The power circuit 133 may continuously detect (e.g., monitor) the level of the parameter of the smart lights 104a-n that are connected to the power supply 102 and control the switch 131 based on a comparison between the level of the parameter and the pre-determined profile as discussed in detail below.

In some embodiments, the power supply 102 may perform the operations described in the present disclosure (e.g., perform power protection of the smart lights 104a-n) when the smart lights 104a-n initially receive power (e.g., power up of the power supply 102, a connection event of the smart lights 104a-n, or any other appropriate initialization event). In these and other embodiments, the power supply 102 may control the switch 131 to create an open without a lighting signal, a frame, or any other type of data being sent to the smart lights 104a-n to initiate the lighting program.

The power circuit 133 may detect the level of the parameter when the smart lights 104a-n are operating in accordance with the frames of the lighting program. In other words, the power circuit 133 may measure and/or detect actual power consumption of the smart lights 104a-n when the smart lights 104a-n are operating in accordance with one or more frames of the lighting program. Each frame may correspond to a lighting signal for the smart lights 104a-n to turn one or more of the channels of the smart lights 104a-n on at particular brightnesses for a period of time. For example, a frame may correspond to a lighting signal configured to cause the smart lights 104a-n to operate at half brightness with a portion of the smart lights 104a-n illuminating red and another portion of the smart lights 104a-n illuminating blue. As another example, a frame may correspond to a lighting signal configured to cause a portion of the smart lights 104a-n to operate at full brightness and to illuminate blue and another portion of the smart lights 104a-n to operate at partial brightness and to illuminate yellow. In some embodiments, the smart lights 104a-n may operate in accordance with a frame until a subsequent lighting signal corresponding to another frame is received by the smart lights 104-n. The lighting program may include the smart lights 104a-n operating in accordance with a sequence of frames in succession.

The power circuit 133 may identify the frame of the lighting program corresponding to the detected level of the parameter of the smart lights 104a-n that are connected to the power supply 102. The power circuit 133 may identify the frame corresponding to the detected level of the parameter to determine an expected level of the parameter for the identified frame. For example, the power circuit 133 may identify settings of the smart lights 104a-n (e.g., a brightness, a color, number of lights on) corresponding to the identified frame and the pre-determined profile may indicate a level of the parameter corresponding to the identified settings. In some embodiments, the level of the parameter corresponding to the identified settings may include an expected level of the parameter (e.g., a threshold value) corresponding to a brightness of the smart lights 104a-n, a color that the smart lights 104a-n are illuminating, a number of the smart lights 104a-n that are illuminating, or any other appropriate setting. In other embodiments, the power circuit 133 may sum the level of the parameter corresponding to the identified frame to determine the expected level of the parameter for the frame.

The power circuit 133 may compare the detected level of the parameter of the frame to the corresponding expected level to determine if the smart lights 104a-n are operating in accordance with the pre-determined profile. Alternatively, the power circuit 133 may compare the level of the detected parameter to the corresponding expected level to determine a difference between the detected level of the parameter and the corresponding expected level to determine if the smart lights 104a-n are operating in accordance with the pre-determined profile. For example, the detected level of the parameter may be equal to 2.1 A and the expected level of the parameter may be equal to 1.3 A and, therefore, the difference is equal to eight hundred milliamps. The power circuit 133 may compare the difference between the level of the parameter and the corresponding expected level to an error rate (e.g., a threshold value) of the power circuit 133.

In some embodiments, the power circuit 133 may compare the level of the detected parameter to the corresponding expected level and/or determine the difference between the level of the parameter and the corresponding expected level for every frame of the lighting program. In other embodiments, the power circuit 133 may compare the level of the parameter to the corresponding expected level and/or determine the difference between the level of the parameter and the corresponding expected level only for a portion of the frames of the lighting program. For example, the power circuit 133 may compare the level of the parameter to the corresponding expected level of the parameter every third frame of the lighting program.

If the power circuit 133 determines that the smart lights 104a-n are operating in accordance with the pre-determined profile, the power circuit 133 may continue to detect the level of the parameter for subsequent frames. For example, if the level of the parameter does not exceed the expected level of the parameter, the power circuit 133 may continue to detect the level of the parameter for subsequent frames. As another example, if the difference between the level of the parameter and the corresponding expected level is less than the error rate of the power circuit 133, the power circuit 133 may continue to detect the level of the parameter for subsequent frames.

If the power circuit 133 determines that the smart lights 104a-n are not operating in accordance with the pre-determined profile, the power circuit 133 may cause the switch 131 to transition to the open state and disconnect the smart lights 104a-n from the power supply 102. In other words, if the power circuit 133 determines that the smart lights 104a-n are not operating in accordance with the pre-determined profile, the power circuit 133 may cause the switch 131 to transition to the open state to electrically uncouple the power supply 102 form the smart lights 104a-n and prevent the power supply 102 from providing power to the smart lights 104a-n For example, if the detected level of the parameter exceeds the corresponding expected level of the parameter, the power circuit 133 may cause the switch 131 to transition to the open state and disconnect the smart lights 104a-n from the power supply 102. As another example, if the difference between the detected level of the parameter and the corresponding expected level is greater than the error rate of the power circuit 133, the power circuit 133 may cause the switch 131 to transition to the open state and disconnect the smart lights 104a-n from the power supply 102.

Additionally, if the power circuit 133 determines that the smart lights 104a-n are not operating in accordance with the pre-determined profile, the power circuit 133 may transmit a message to the remote device 119 via the network 117. For example, responsive to the detected level of the parameter being greater than the corresponding expected level, the power circuit 133 may transmit a message to the remote device 119 via the network 117. As another example, responsive to the difference between the detected level of the parameter and the corresponding expected level being greater than the error rate of the power circuit 133, the power circuit 133 may transmit a message to the remote device 119 via the network 117. The message may indicate that the smart lights 104a-n are not operating in accordance with the pre-determined profile.

In some embodiments, the controller 118 may generate the pre-determined profile for each channel of each of the smart lights as discussed in detail elsewhere in the present disclosure. The pre-determined profile may indicate the expected levels of the parameter of the smart lights 104a-n that are connected to the power supply 102 for different settings of the smart lights 104a-n. In some embodiments, the expected levels of the parameter of the smart lights 104a-n that are connected to the power supply 102 may correspond to different channels of the smart lights 104a-n being on, a different portion of the smart lights 104a-n being on, or any other appropriate setting.

In some embodiments, if the power circuit 133 determines that the smart lights 104a-n are not operating in accordance with the pre-determined profile, the power circuit 133 may perform additional checks to ensure an error in the smart lights 104a-n is actually occurring. In these embodiments, the smart lights 104a-n may be instructed to turn off (e.g., operate in accordance with an empty frame) and the power circuit 133 may detect a level of a quiescent current and/or quiescent power of the smart lights 104a-n.

The power circuit 133 may compare the level of the quiescent current and/or the quiescent power to corresponding expected levels of the quiescent current and/or the quiescent power. If the level of the quiescent current and/or the quiescent power is the same or similar to the expected levels of the quiescent current and/or the quiescent power, the error may be identified as a false positive and the power circuit 133 may continue to perform power protection for subsequent frames. Additionally or alternatively, the power circuit 133 may adjust the corresponding expected level of the parameter (e.g., the expected level of the parameter corresponding to the setting of the frame) to reduce the likelihood of another false positive occurring. For example, the power circuit 133 may increase the expected levels of the parameter corresponding to the settings of the identified frame. If the level of the quiescent current and/or the quiescent power is not the same or similar to the expected levels of the quiescent current and/or the quiescent power, the power circuit 133 may cause the switch 131 to transition to the open state.

In some embodiments, the power supply 102 may perform power protection of the smart lights 104a-n when the smart lights 104a-n are not operating in accordance with the lighting program. The smart lights 104a-n may receive one or more termination signals but may continue to receive power from the power supply 102. In other words, the smart lights 104a-n may be operating in a standby mode and waiting for lighting signals indicating that a lighting program is to be initiated. The switch 131 may be in the closed state and the smart lights 104a-n may be connected to the power supply 102 (e.g., receiving quiescent current and/or quiescent power).

The power circuit 133 may detect the level of the quiescent current and/or quiescent power of the smart lights 104a-n. In addition, the power circuit 133 may compare the level of the quiescent current and/or the quiescent power to corresponding expected levels of the quiescent current and/or the quiescent power. If the level of the quiescent current and/or the quiescent power is the same or similar to the expected levels of the quiescent current and/or the quiescent power, the power circuit 133 may continue to perform power protection while the smart lights 104a-n are waiting for subsequent lighting signals (e.g., subsequent frames). If the level of the quiescent current and/or the quiescent power is not the same or similar to the expected levels of the quiescent current and/or the quiescent power, the power circuit 133 may cause the switch 131 to transition to the open state.

An example of the power circuit 133 performing power protection of the smart lights 104a-n when operating in accordance with a frame that causes the white channels of the smart lights 104a-b to turn on at full brightness and the smart lights 104c-n to turn off will now be discussed. The controller 118 may transmit a lighting signal corresponding to the frame to the smart lights 104a-n. The smart lights 104a-n may operate in accordance with the frame (e.g., the smart lights 104a-b may turn on the white channels at full brightness and the smart lights 104c-n may turn off).

The power circuit 133 may detect the level of the parameter (e.g., the current, the power, or the voltage) of the smart lights 104a-n that are connected to the power supply 102 when the smart lights 104a-b are operating in accordance with the frame. The power circuit 133 may identify the frame as corresponding to the detected level of the parameter. For example, the power circuit 133 may identify the frame as corresponding to the smart lights 104a-b turning on the white channels at full brightness. In addition, the power circuit 133 may determine an expected level of the parameter based on the identified frame. For example, the power circuit 133 may determine the expected level of the parameter when the smart lights 104a-b are illuminating white at full brightness based on the identified frame.

The power circuit 133 may compare the detected level of the parameter to the expected level corresponding to the identified frame. Alternatively, the power circuit 133 may determine a difference between the detected level of the parameter and the corresponding expected level. If the detected level of the parameter exceeds the expected level or the difference between the detected level of the parameter and the corresponding expected level exceed a corresponding threshold level (e.g., the error rate of the power circuit 133), the power circuit 133 may cause the switch 131 to transition to the open state. Additionally, the power circuit 133 may transmit the message to the remote device 119 via the network 117.

In some embodiments, the power circuit 133 may be configured to determine a change in the detected level of the parameter between frames. In these and other embodiments, the power circuit 133 may determine an expected difference between the expected levels corresponding to the different frames. If the change in the detected level of the parameter between frames exceeds the expected difference between the expected levels, the power circuit 133 may cause the switch 131 to transition to the open state and/or transmit the message.

In these and other embodiments, the power circuit 133 may compare a difference between the change in the detected level of the parameter between frames and the expected difference between the expected levels to the error rate of the power circuit 133. If the difference between the change in the detected level of the parameter between frames and the expected difference between the expected levels exceeds the error rate of the power circuit 133, the power circuit 133 may cause the switch to transition to the open state and/or transmit the message. For example, the error rate of the power circuit 133 may be equal eight hundred milliamps and if the difference between the change in the detected level of the parameter between frames and the expected difference between the expected levels is greater than eight hundred milliamps, the power circuit 133 may cause the switch to transition to the open state and/or transmit the message.

Alternatively, the power circuit 133 may determine if the difference between the change in the detected level of the parameter between frames and the expected difference between the expected levels exceeds a threshold percentage of the expected difference between expected levels. For example, if the threshold percentage is equal to twenty percent, the expected difference is four hundred milliamps, and the difference between the change in the detected level of the parameter between frames is four hundred ninety milliamps, the power circuit 133 may cause the switch 131 to transition to the open state and/or transmit the message because ninety milliamps is greater than twenty percent of four hundred milliamps.

Referring to FIG. 2, the power supply 102 includes the power circuit 133 and the switch 131 to perform power detection of the strand 207 of smart lights 104a-n, 214a-x, 216a-b, in accordance with at least one embodiment described in the present disclosure. The power circuit 133 may detect the level of the parameter of the smart lights 104a-n, 214a-x, 216a-b that are connected to the power supply 102 when the smart lights 104a-n, 214a-x, 216a-b are operating in accordance with a frame in similar manners as discussed above in relation to FIG. 1. However, the power circuit 133 will account for the duplicative nature of the parallel branches 201, 203, 205 when comparing detected level(s) to corresponding expected level(s).

Referring to FIG. 3, the power supply 302 includes the power circuit 133 and the switch 131 to perform power detection of the strand 305 of smart lights 104a-n, in accordance with at least one embodiment described in the present disclosure. The power circuit 133/power supply 302 may communicate with the detection circuit 116, the network 117, or both via a wireless communication link (represented by the dashed and double arrow lines in FIG. 3). In some embodiments, the wireless communication link may use any wireless communication protocol to communicatively couple the power circuit 133 with the remote device 119. In some embodiments, the wireless communication protocol may include Wi-Fi®, Bluetooth®, Bluetooth Low Energy®, Zigbee®, or WiMax®. In other embodiments, the wireless communication protocol may be a network, or combination of multiple networks, configured to send and receive communications between systems and devices. For example, the wireless communication protocol may include a Personal Area Network (PAN), a Local Area Network (LAN), a Metropolitan Area Network (MAN), a Wide Area Network (WAN), a Storage Area Network (SAN), a cellular network, the Internet, a long range (LoRa) network, or some combination thereof. Alternatively, the power circuit 133 may communicate with the detection circuit 116, the network, or both via a wired link. The power circuit 133 may inspect the smart lights 104a-n in the same or similar manners as discussed above in relation to FIG. 1.

Referring to FIG. 4A, the power supply 302 includes the power circuit 133 and the switch 131 to perform power detection of the strand 405a of the smart lights 104a-n, in accordance with at least one embodiment described in the present disclosure. The power circuit 133 may detect the level of the parameter of the smart lights 104a-n that are connected to the power supply 302 as described above.

Referring to FIG. 4B, each of the power supplies 302a-b include an instance of the power circuit 133a-b and the switch 131a-b to perform power detection of the strand 405b, in accordance with at least one embodiment described in the present disclosure. The power circuits 133a-b may detect the level of the parameter of the smart lights 104a-n that are connected to the power supplies 302a-b as described above.

The power circuits 133a-b may independently perform power detection of corresponding portions of the smart lights 104a-n. For example, the power circuit 133a may perform power detection of the smart lights 104a-d and the power circuit 133b may perform power detection of the smart lights 104e-n. Additionally, the power circuit 133a-b may use different pre-determined profiles for the corresponding smart lights 104a-n. For example, the power circuit 133a may use a pre-determined profile that corresponds to the smart lights 104a-d and the power circuit 133b may use a pre-determined profile that corresponds to the smart lights 104e-n.

Referring to FIG. 5A, the power supply 302 includes the power circuit 133 and the switch 131 to perform power detection of the strand 505a of smart lights 104a-n that form different branches 501a, 503a and include multiple controllers 518a-b, in accordance with at least one embodiment described in the present disclosure. The power circuit 133 may detect the level of the parameter of the smart lights 104a-n that are connected to the power supply 302 as described above.

Referring to FIG. 5B, each of the power supplies 302a-b include an instance of the power circuit 133a-b and the switch 131a-b to perform power detection of the strand 505b of smart lights 104a-n that form different branches 501b, 503b, in accordance with at least one embodiment described in the present disclosure. The power circuits 133a-b may detect the level of the parameter of the smart lights 104a-n that are connected to the power supplies 302a-b as described above. For example, the power circuit 133a may detect the level of the parameters of the smart lights 104a-f that are connected to the power supply 302a and the power circuit 133b may detect the level of the smart lights 104g-n that are connected to the power supply 302b.

Referring to FIG. 6, the power supply 302 includes the power circuit 133 and the switch 131 to perform power detection of the strand 605 of smart lights 604a-n, in accordance with at least one embodiment described in the present disclosure. The power circuit 133 may detect the level of the parameter of the smart lights 604a-n that are connected to the power supply 302 as described above.

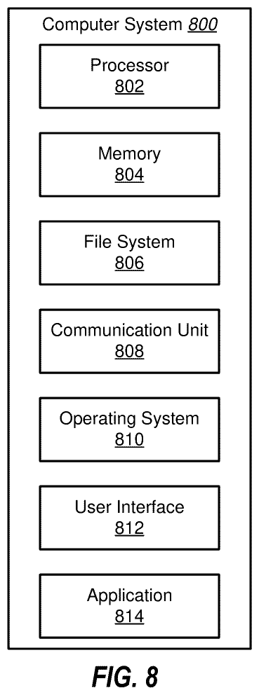

FIG. 8 illustrates an example computer system 800 that may be employed for inspecting smart lights. In some embodiments, the computer system 800 may be part of any of the systems or devices described in this disclosure. For example, the computer system 800 may be part of any of the controllers 118, 318, 518a-b, 618 and the smart lights 104a-n, 214a-x, 216a-b, 604a-n.

The computer system 800 may include a processor 802, a memory 804, a file system 806, a communication unit 808, an operating system 810, a user interface 812, and an application 814, which all may be communicatively coupled. In some embodiments, the computer system 800 may be, for example, a desktop computer, a client computer, a server computer, a mobile phone, a laptop computer, a smartphone, a smartwatch, a tablet computer, a portable music player, a networking device, or any other computer system.

Generally, the processor 802 may include any suitable special-purpose or general-purpose computer, computing entity, or processing device including various computer hardware or software applications and may be configured to execute instructions stored on any applicable computer-readable storage media. For example, the processor 802 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 802 may interpret and/or execute program instructions and/or process data stored in the memory 804 and/or the file system 806. In some embodiments, the processor 802 may fetch program instructions from the file system 806 and load the program instructions into the memory 804. After the program instructions are loaded into the memory 804, the processor 802 may execute the program instructions. In some embodiments, the instructions may include the processor 802 performing one or more of the actions disclosed herein.

The memory 804 and the file system 806 may include computer-readable storage media for carrying or having stored thereon computer-executable instructions or data structures. Such computer-readable storage media may be any available non-transitory media that may be accessed by a general-purpose or special-purpose computer, such as the processor 802. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 802 to perform a certain operation or group of operations, such as one or more of the actions disclosed herein. These computer-executable instructions may be included, for example, in the operating system 810.

The communication unit 808 may include any component, device, system, or combination thereof configured to transmit or receive information over a network, such as the wireless communication link described above. In some embodiments, the communication unit 808 may communicate with other devices at other locations, the same location, or even other components within the same system. For example, the communication unit 808 may include a modem, a network card (wireless or wired), an infrared communication device, a wireless communication device (such as an antenna), and/or chipset (such as a Bluetooth® device, an 802.6 device (e.g., Metropolitan Area Network (MAN)), a Wi-Fi® device, a WiMax® device, a cellular communication device, etc.), and/or the like. The communication unit 808 may permit data to be exchanged with a network and/or any other devices or systems, such as those described in the present disclosure.

The operating system 810 may be configured to manage hardware and software resources of the computer system 800 and configured to provide common services for the computer system 800.

The user interface 812 may include any device configured to allow a user to interface with the computer system 800. For example, the user interface 812 may include a display, such as an LCD, LED, or other display, that is configured to present video, text, application user interfaces, and other data as directed by the processor 802. The user interface 812 may further include a mouse, a track pad, a keyboard, a touchscreen, volume controls, other buttons, a speaker, a microphone, a camera, any peripheral device, or other input or output device. The user interface 812 may receive input from a user and provide the input to the processor 802. Similarly, the user interface 812 may present output to a user.

The application 814 may be one or more computer-readable instructions stored on one or more non-transitory computer-readable media, such as the memory 804 or the file system 806, that, when executed by the processor 802, is configured to perform one or more of the actions of the disclosed herein. In some embodiments, the application 814 may be part of the operating system 810 or may be part of an application of the computer system 800, or may be some combination thereof.

Modifications, additions, or omissions may be made to the computer system 800 without departing from the scope of the present disclosure. For example, although each is illustrated as a single component in FIG. 8, any of the components 802-814 of the computer system 800 may include multiple similar components that function collectively and are communicatively coupled. Further, although illustrated as a single computer system, it is understood that the computer system 800 may include multiple physical or virtual computer systems that are networked together, such as in a cloud computing environment, a multitenancy environment, or a virtualization environment.

As indicated above, the embodiments described herein may include the use of a special purpose or general purpose computer (e.g., the processor 802 of FIG. 8) including various computer hardware or software applications, as discussed in greater detail below. Further, as indicated above, embodiments described herein may be implemented using computer-readable media (e.g., the memory 804 or file system 806 of FIG. 8) for carrying or having computer-executable instructions or data structures stored thereon.

Embodiments described in the present disclosure may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system comprising:
a detection circuit configured to detect a parameter of a plurality of smart lights that are connected to a power supply;
a controller communicatively coupled to the detection circuit and the plurality of smart lights, each of the smart lights comprising a plurality of channels, the controller configured to:
transmit a lighting signal addressed to a portion of the plurality of smart lights, the lighting signal configured to cause particular channels of the portion of the plurality of smart lights to turn on;
receive a parameter message from the detection circuit indicating a level of the parameter of the plurality of smart lights that are connected to the power supply when the particular channels of the portion of the plurality of smart lights are on;
compare the level of the parameter of the plurality of smart lights that are connected to the power supply to a threshold value range; and
responsive to the level of the parameter of the plurality of smart lights that are connected to the power supply being outside of the threshold value range, transmit a message to a remote device, the message indicating that the particular channels of the portion of the plurality of smart lights are not operating in accordance with a pre-determined profile.

2. The system of claim 1, wherein the portion of the plurality of smart lights comprises a first portion of the plurality of smart lights, the lighting signal comprises a first lighting signal, the message comprises a first message, and the controller is configured to:
transmit a termination signal addressed to the first portion of the plurality of smart lights to cause the particular channels of the first portion of the plurality of smart lights to turn off;
transmit a second lighting signal addressed to a second portion of the plurality of the smart lights, the second lighting signal configured to cause particular channels of the second portion of the plurality of smart lights to turn on;
receive another parameter message from the detection circuit indicating the level of the parameter of the plurality of smart lights that are connected to the power supply when the particular channels of the second portion of the plurality of smart lights are on;
compare the level of the parameter of the plurality of smart lights that are connected to the power supply when the particular channels of the second portion of the plurality of smart lights are on to another threshold value range; and
responsive to the level of the parameter of the plurality of smart lights that are connected to the power supply when the particular channels of the second portion of the plurality of smart lights are on being outside of the another threshold value range, transmit a second message to the remote device, the second message indicating that the particular channels of the second portion of the plurality of smart lights are not operating in accordance with the pre-determined profile.

3. The system of claim 1, wherein:
the portion of the plurality of smart lights comprises a first portion of the plurality of smart lights within a first branch;
the controller is configured to transmit the lighting signal addressed to a second portion of the plurality of smart lights within a second branch, the lighting signal configured to cause corresponding particular channels of the second portion of the plurality of smart lights to turn on;
the parameter message from the detection circuit indicates the level of the parameter of the plurality of smart lights that are connected to the power supply when the particular channels of the first portion and the second portion of the plurality of smart lights on; and
the message indicates that the particular channels of the first portion and the second portion of the plurality of smart lights are not operating in accordance with the pre-determined profile.

4. The system of claim 1, wherein:
the controller comprises a first controller, the portion of the plurality of smart lights comprises a first portion of the plurality of smart lights within a first branch, the lighting signal comprises a first lighting signal, the message comprises a first message,
the first controller is configured to transmit a termination signal to the first portion of the plurality of smart lights to cause the particular channels of the first portion of the plurality of smart lights to turn off; and
the system comprises a second controller configured to:
transmit a second lighting signal addressed to a second portion of the plurality of smart lights within a second branch that is parallel to the first branch, the second lighting signal configured to cause particular channels of the second portion of the plurality of smart lights to turn on;
receive another parameter message from the detection circuit indicating the level of the parameter of the plurality of smart lights that are connected to the power supply when the particular channels of the second portion of the plurality of smart lights are on;
compare the level of the parameter of the plurality of smart lights that are connected to the power supply when the particular channels of the second portion of the plurality of smart lights are on to the threshold value range; and
responsive to the level of the parameter of the plurality of smart lights that are connected to the power supply when the particular channels of the second portion of the plurality of smart lights are on being outside of the threshold value range, transmit a second message to the remote device, the second message indicating that the particular channels of the second portion of the plurality of smart lights are not operating in accordance with the pre-determined profile.

5. The system of claim 1, wherein:
the controller is configured to transmit a synchronization signal to the detection circuit; and
the detection circuit is configured to start detecting the level of the parameter of the plurality of smart lights that are connected to the power supply in response to the synchronization signal.

6. The system of claim 1, wherein the parameter comprises at least one of:
a level of current being provided to the plurality of smart lights by the power supply; or
a level of power being provided to the plurality of smart lights by the power supply.

7. A system comprising:
a detection circuit configured to detect a parameter of a plurality of smart lights that are connected to a power supply;
a controller communicatively coupled to the detection circuit and the plurality of smart lights, each of the smart lights comprising a plurality of channels, wherein the controller is configured to:
transmit a lighting signal addressed to a particular smart light of the plurality of smart lights, the lighting signal configured to cause a particular channel of the particular smart light to turn on;
receive a parameter message from the detection circuit indicating a level of the parameter of the plurality of smart lights that are connected to the power supply when the particular channel is on;
compare the level of the parameter of the plurality of smart lights that are connected to the power supply to a threshold value range; and
responsive to the level of the parameter of the plurality of smart lights that are connected to the power supply being outside of the threshold value range, transmit a message to a remote device, the message indicating that the particular channel is not operating in accordance with a pre-determined profile.

8. The system of claim 7, wherein the particular channel comprises a first channel of the particular smart light, the lighting signal comprises a first lighting signal, the message comprises a first message, and the controller is configured to:
transmit a termination signal addressed to the particular smart light to cause the first channel to turn off;
transmit a second lighting signal addressed to the particular smart light, the second lighting signal configured to cause a second channel of the particular smart light to turn on;
receive another parameter message from the detection circuit indicating the level of the parameter of the plurality of smart lights that are connected to the power supply when the second channel is on;
compare the level of the parameter of the plurality of smart lights that are connected to the power supply when the second channel is on to another threshold value range; and
responsive to the level of the parameter of the plurality of smart lights that are connected to the power supply when the second channel is on being outside of the another threshold value range, transmit a second message to the remote device, the second message indicating that the second channel is not operating in accordance with the pre-determined profile.

9. The system of claim 7, wherein the particular smart light comprises a first smart light, the lighting signal comprises a first lighting signal, the message comprises a first message, and the controller is configured to:
transmit a termination signal addressed to the first smart light to cause the particular channel of the first smart light to turn off;
transmit a second lighting signal addressed to a second smart light of the plurality of smart lights, the second lighting signal configured to cause the particular channel of the second smart light to turn on;
receive another parameter message from the detection circuit indicating the level of the parameter of the plurality of smart lights that are connected to the power supply when the particular channel of the second smart light is on;
compare the level of the parameter of the plurality of smart lights that are connected to the power supply when the particular channel of the second smart light is on to the threshold value range; and
responsive to the level of the parameter of the plurality of smart lights that are connected to the power supply when the particular channel of the second smart light is on being outside of the threshold value range, transmit a second message to the remote device, the second message indicating that the particular channel of the second smart light is not operating in accordance with the pre-determined profile.

10. The system of claim 7, wherein:
the particular smart light comprises a first smart light within a first branch;
the controller is configured to transmit the lighting signal addressed to a second smart light of the plurality of smart lights within a second branch, the lighting signal configured to cause a corresponding particular channel of the second smart light to turn on;
the parameter message from the detection circuit indicates the level of the parameter of the plurality of smart lights that are connected to the power supply when the particular channels of the first smart light and the second smart light are on; and
the message indicates that the particular channels of the first smart light and the second smart light are not operating in accordance with the pre-determined profile.

11. The system of claim 7, wherein:
the controller comprises a first controller, the particular smart light comprises a first smart light within a first branch, the lighting signal comprises a first lighting signal, the message comprises a first message,
the first controller is configured to transmit a termination signal addressed to the first smart light to cause the particular channel of the first smart light to turn off; and
the system comprises a second controller configured to:
transmit a second lighting signal addressed to a second smart light of the plurality of smart lights within a second branch that is parallel to the first branch, the second lighting signal configured to cause the particular channel of the second smart light to turn on;
receive another parameter message from the detection circuit indicating the level of the parameter of the plurality of smart lights that are connected to the power supply when the particular channel of the second smart light is on;
compare the level of the parameter of the plurality of smart lights that are connected to the power supply when the particular channel of the second smart light is on to the threshold value range; and
responsive to the level of the parameter of the plurality of smart lights that are connected to the power supply when the particular channel of the second smart light is on being outside of the threshold value range, transmit a second message to the remote device, the second message indicating that the particular channel of the second smart light is not operating in accordance with the pre-determined profile.

12. The system of claim 7, wherein the parameter comprises a current level and the compare the level of the parameter of the plurality of smart lights that are connected to the power supply to the threshold value range comprises:
determine a power level of the particular channel based on the current level of the power supply; and
compare the power level of the particular channel to the threshold value range.

13. A system comprising:
a power supply configured to provide power to a plurality of smart lights, the power supply comprising:
a switch configured to selectively electrically couple the power supply to the plurality of smart lights; and
a power circuit coupled to the switch, the power circuit being configured to:
detect a level of a parameter of the plurality of smart lights that are connected to the power supply when the plurality of smart lights are operating in accordance with a frame of a lighting program;
compare the level of the parameter to a pre-determined profile, the pre-determined profile corresponding to the plurality of smart lights and the frame of the lighting program; and
control, based on the comparison, the switch to control the electrical coupling of the power supply to the plurality of smart lights and the power provided to the plurality of smart lights by the power supply.

14. The system of claim 13, wherein, responsive to the level of the parameter being greater than a corresponding threshold value in the pre-determined profile, the control, based on the comparison, the switch to control the electrical coupling of the power supply to the plurality of smart lights and the power provided to the plurality of smart lights by the power supply comprises:
causing the switch to transition to an open state to electrically uncouple the power supply from the plurality of smart lights and to prevent the power supply from providing power to the plurality of smart lights; and
transmitting a message to a remote device, the message indicating that the plurality of smart lights are not operating in accordance with the pre-determined profile.

15. The system of claim 13 further comprising a controller communicatively coupled to the plurality of smart lights, wherein:
each of the smart lights comprises a plurality of channels; and
the controller is configured to generate the pre-determined profile of each channel of each of the smart lights, the pre-determined profile comprising a plurality of expected levels of the parameter of the plurality of smart lights that are connected to the power supply, wherein each of the expected levels of the parameter of the plurality of smart lights that are connected to the power supply corresponds to a different channel of the plurality of channels and a different smart light of the plurality of smart lights.

16. The system of claim 15, wherein the generate the pre-determined profile of each channel of each of the smart lights comprises:
transmitting, by the controller, lighting signals to the plurality of smart lights, each of the lighting signals configured to cause at least one channel of at least a portion of the plurality of smart lights to turn on;
detecting, by the power circuit, the level of the parameter of the plurality of smart lights that are connected to the power supply when the plurality of smart lights are operating in accordance with each of the lighting signals; and
generating the pre-determined profile to indicate the level of the parameter of the plurality of smart lights that are connected to the power supply when the plurality of smart lights are operating in accordance with each of the lighting signals.

17. The system of claim 13, wherein the compare the level of the parameter to the pre-determined profile comprises:
identifying the frame of the lighting program;
determining a threshold value for the plurality of smart lights based on at least one of:
the frame of the lighting program;
an error rate of the power circuit; or
corresponding expected levels of the parameter of the plurality of smart lights that are connected to the power supply of corresponding channels of the smart lights; and
comparing the level of the parameter to the threshold value.

18. The system of claim 13, wherein the power circuit is configured to start detecting the level of the parameter of the plurality of smart lights that are connected to the power supply in response to a synchronization signal.

19. The system of claim 13, wherein the parameter comprises at least one of:
a level of current being supplied to the plurality of smart lights by the power supply; or
a level of power being supplied to the plurality of smart lights by the power supply.

20. The system of claim 13, wherein the power circuit is configured to:
detect the level of the parameter of the plurality of smart lights that are connected to the power supply when the plurality of smart lights are operating in accordance with another frame of the lighting program;
compare the level of the parameter corresponding to the another frame of the lighting program to the pre-determined profile, the pre-determined profile corresponding to the plurality of smart lights and the another frame of the lighting program; and
control, based on the comparison of the level of the parameter corresponding to the another frame of the lighting program to the pre-determined profile, the switch to control the electrical coupling of the power supply to the plurality of smart lights and the power provided to the plurality of smart lights by the power supply.
